(19) United States
(12) Patent Application Publication
(10) Pub. No.: US 2013/0298129 A1
(43) Pub. Date: Nov. 7, 2013

(54) CONTROLLING A SEQUENCE OF PARALLEL EXECUTIONS

(71) Applicants: Alexander Rabinovitch, Kafa Yona (IL); Leonid Dubrovin, Karney Shomron (IL); Amichay Amitay, Hod Hasharon (IL)

(72) Inventors: Alexander Rabinovitch, Kafa Yona (IL); Leonid Dubrovin, Karney Shomron (IL); Amichay Amitay, Hod Hasharon (IL)

(21) Appl. No.: 13/465,179

(22) Filed: May 7, 2012

(51) Int. Cl. G06F 9/46

(52) U.S. Cl. 718/102

(57) ABSTRACT

An apparatus having a first circuit and a plurality of second circuits is disclosed. The first circuit may be configured to dispatch a plurality of sets in a sequence. Each set generally includes a plurality of instructions. The second circuits may be configured to (i) execute the sets during a plurality of execution cycles respectively and (ii) stop the execution in a particular one of the second circuits during one or more of the execution cycles in response to an expiration of a particular counter that corresponds to the particular second circuit.

### FIELD OF THE INVENTION

The present invention relates to digital signal processors generally and, more particularly, to a method and/or apparatus for controlling a sequence of parallel executions.

### BACKGROUND OF THE INVENTION

Hardware loops are used in all modern digital signal processors (i.e., DSP). Two categories of the hardware loops exist: “short” loops and “long” loops. A main difference between the short loops and the long loops is usage of a special buffer located inside the processing core to store instructions for the short loop execution. In the long loop case, the instructions are fetched from a memory, commonly a program cache, for each loop iteration. The modern DSP cores also use a growing number of parallel heterogeneous processing units, implementing different functionality, to increase a core processing power and parallelism. Using many processing units with different functions makes it harder to create the short loops.

The modern DSP cores support multiple instruction execution in a single cycle. Creating a code that will utilize all of the processing units in the optimal way is challenging. For example, lossless compression parts of a context-adaptive variable length coding (i.e., CAVLC) and a context-based adaptive binary arithmetic coding (i.e., CABAC) of an H.264 video encoder can be problematic for optimization. When implementing the CAVLC or CABAC techniques, a programmer often comes to the following functional dependencies. A code_block_1 calculates locations of non-zero elements in a 4×4 video block. The code_block_1 also generates results for a number of non-zero elements (i.e., N), a number of zero elements (i.e., Z) and an array of zero elements locations (i.e., A[Z]). A code_block_2 is based on the results of the code_block_1. The code_block_2 calculates the locations of the zero elements stored into a memory. A code_block_3 uses the results of the code_block_1 to find which of the non-zero elements have a value of one. The one-value elements are located because the one-value elements have special treatment during the encoding process. The code counts the one-value elements and perform other operations on non-one-value elements. The code_block_3 is longer than the code_block_2 and so takes more execution cycles to complete.

Theoretically the code_block_2 and the code_block_3 can be executed in parallel, thus allowing utilization of parallel execution slots of the DSP. In practice the code_block_2 is executed a non-constant number of times because Z can vary from 0 to 15. The non-constant number Z makes parallelization complex because the value of Z is not known in advance. The non-constant number Z also makes hardware loops difficult because although the code_block_2 has loop friendly behavior, the code_block_3 is a non-repeating code with linear dependencies. Therefore, instead of a single operation for each element of A[Z] (i.e., storing the indication to a video stream), two additional instructions are executed. The two additional instructions are (i) a decrement instruction and (ii) a comparison of the decremented result to zero to decide whether the next store instruction should be executed. Parallel execution of the code_block_2 with that of the code_block_3 utilizes three execution slots in each cycle. Only one of the three slots is functional and the other two slots simply imitate a loop behavior. The two additional slots cause an increase in a code size and thus additional miss cycles and power consumption of the program cache. In addition, if operation of the code_block_3 leaves less than three empty execution slots in any given execution cycle, additional cycles will be consumed.

It would be desirable to implement a method and/or apparatus for controlling a sequence of parallel executions.

### SUMMARY OF THE INVENTION

The present invention concerns an apparatus having a first circuit and a plurality of second circuits. The first circuit may be configured to dispatch a plurality of sets in a sequence. Each set generally includes a plurality of instructions. The second circuits may be configured to (i) execute the sets during a plurality of execution cycles respectively and (ii) stop the execution in a particular one of the second circuits during one or more of the execution cycles in response to an expiration of a particular counter that corresponds to the particular second circuit.

The objects, features and advantages of the present invention include providing a method and/or apparatus for controlling a sequence of parallel executions that may (i) utilize independent short hardware loops for each execution unit or set of units, (ii) provide an allocating instruction buffer per execution unit, (iii) provide a capability to run a different number of loop iterations on each execution unit, (iv) utilize multiple hardware execution slots counters each of which define a number of cycles when a corresponding execution slot is operational, (v) provide assembly language directives and instructions for programming hardware execution slots counters and/or (vi) be implemented in a digital signal processor core.

### BRIEF DESCRIPTION OF THE DRAWINGS

These and other objects, features and advantages of the present invention will be apparent from the following detailed description and the appended claims and drawings in which:

FIG. 1 is a block diagram of an example implementation of an apparatus;

FIG. 2 is a diagram illustrating an order for fetching and dispatching sets of instructions;

FIG. 3 is a block diagram of a portion of the apparatus in accordance with a preferred embodiment of the present invention;

FIG. 4 is a detailed block diagram of an example implementation of an execution control circuit; and

FIG. 5 is a detailed block diagram of an example implementation of a unit control logic circuit.

### DETAILED DESCRIPTION OF THE PREFERRED EMBODIMENTS

Some embodiments of the present invention generally provide short hardware loop buffers within multiple execution units of a very long instruction word (e.g., VLIW) digital signal processor (e.g., DSP) core. Each short loop buffer may be allocated to each execution unit respectively. The information stored in the short loop buffers generally comprises execution unit specific instructions, but not a whole VLIW. Implementing a short loop buffer corresponding to each execution unit generally enables a software program to run a different number of iterations for each execution unit. Furthermore, multiple hardware execution slot counters may be implemented, each corresponding to one of the execution units respectively. The hardware execution slot counters generally define a number of cycles when the corresponding execution unit is operational. Limiting the number of cycles when an execution unit is operational may improve performance in video codec applications.

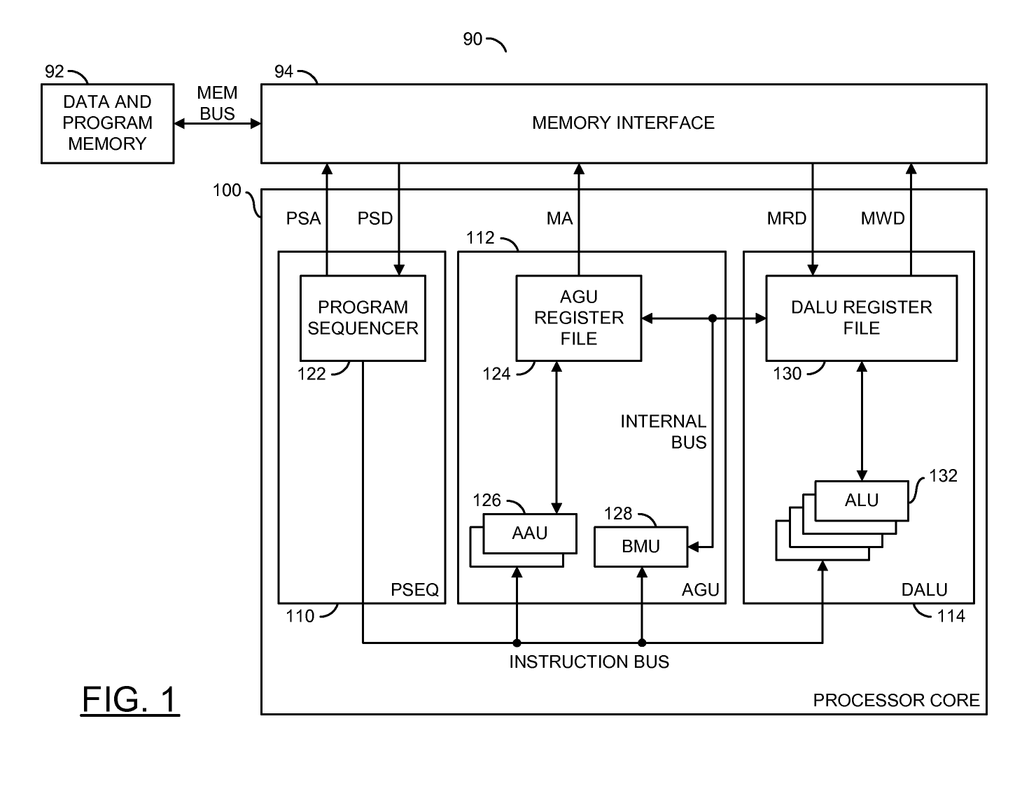

Referring to FIG. 1, a block diagram of an example implementation of an apparatus 90 is shown. The apparatus (or circuit, or device or integrated circuit) 90 may implement a pipelined digital signal processor circuit. The apparatus 90 generally comprises a block (or circuit) 92, a block (or circuit) 94 and the circuit 100. The circuit 100 generally comprises a block (or circuit) 110, a block (or circuit) 112 and a block (or circuit) 114. The circuit 110 generally comprises a block (or circuit) 122. The circuit 112 generally comprises a block (or circuit) 124, one or more blocks (or circuits) 126 and a block (or circuit) 128. The circuit 114 generally comprises a block (or circuit) 130 and one or more blocks (or circuits) 132. The circuits 92-132 may represent modules and/or blocks that may be implemented as hardware, software, a combination of hardware and software, or other implementations. In some embodiments, the circuit 94 may be part of the circuit 100.

A bus (e.g., MEM BUS) may connect the circuit 94 and the circuit 92. A program sequence address signal (e.g., PSA) may be generated by the circuit 122 and transferred to the circuit 94. The circuit 94 may generate and transfer a program sequence data signal (e.g., PSD) to the circuit 122. A memory address signal (e.g., MA) may be generated by the circuit 124 and transferred to the circuit 94. The circuit 94 may generate a memory read data signal (e.g., MRD) received by the circuit 130. A memory write data signal (e.g., MWD) may be generated by the circuit 130 and transferred to the circuit 94. A bus (e.g., INTERNAL BUS) may connect the circuits 124, 128 and 130. A bus (e.g., INSTRUCTION BUS) may connect the circuits 122, 126, 128 and 132.

The circuit 92 may implement a memory circuit. The circuit 92 is generally operational to store both data and instructions used by and generated by the circuit 100. In some embodiments, the circuit 92 may be implemented as two or more circuits with some storing the data and others storing the instructions.

The circuit 94 may implement a memory interface circuit. The circuit 94 may be operational to transfer memory addresses and data between the circuit 92 and the circuit 100. The memory address may include instruction addresses in the signal PSA and data addresses in the signal MA. The data may include instruction data (e.g., the fetch sets) in the signal PSD, read data in the signal MRD and write data in the signal MWD.

The circuit 100 may implement a processor core circuit. The circuit 100 is generally operational to execute (or process) instructions received from the circuit 92. Data consumed by and generated by the instructions may also be read (or loaded) from the circuit 92 and written (or stored) to the circuit 92. The pipeline within the circuit 100 may implement a software pipeline. In some embodiments, the pipeline may implement a hardware pipeline. In other embodiments, the pipeline may implement a combined hardware and software pipeline.

The circuit 110 may implement a program sequencer (e.g., PSEQ) circuit. The circuit 110 is generally operational to generate a sequence of addresses in the signal PSA for the instructions executed by the circuit 100. The addresses may be presented to the circuit 94 and subsequently to the circuit 92. The instructions may be returned to the circuit 110 in the fetch sets read from the circuit 92 through the circuit 94 in the signal PSD.

The circuit 110 is generally configured to store the fetch sets received from the circuit 92 via the signal PSD in the buffer (e.g., the circuit 102). The circuit 110 may parse the fetch sets into individual execution sets. The instruction words in the execution sets may be decoded within the circuit 110 (e.g., using the circuit 106) and presented on the instruction bus to the circuits 126, 128 and 132.

The circuit 112 may implement an address generation unit (e.g., AGU) circuit. The circuit 112 is generally operational to generate addresses for both load and store operations performed by the circuit 100. The addresses may be issued to the circuit 94 via the signal MA.

The circuit 114 may implement a data arithmetic logic unit (e.g., DALU) circuit. The circuit 114 is generally operational to perform core processing of data based on the instructions fetched by the circuit 110. The circuit 114 may receive (e.g., load) data from the circuit 92 through the circuit 94 via the signal MRD. Data may be written (e.g., stored) through the circuit 94 to the circuit 92 via the signal MWD.

The circuit 122 may implement a program sequencer circuit. The circuit is generally operational to prefetch a set of one or more addresses by driving the signal PSA. The prefetch generally enables memory read processes by the circuit 94 at the requested addresses. While an address is being issued to the circuit 92, the circuit 122 may update a fetch counter for a next program memory read. Issuing the requested address from the circuit 94 to the circuit 92 may occur in parallel to the circuit 122 updating the fetch counter.

The circuit 124 may implement an AGU register file circuit. The circuit 124 may be operational to buffer one or more addresses generated by the circuits 126 and 128. The addresses may be presented by the circuit 124 to the circuit 94 via the signal MA.

The circuit 126 may implement one or more (e.g., two) address arithmetic unit (e.g., AAU) circuits. Each circuit 126 may be operational to perform address register modifications. Several addressing modes may modify the selected address registers within the circuit 124 in a read-modify-write fashion. An address register is generally read, the contents modified by an associated modulo arithmetic operation, and the modified address is written back into the address register from the circuit 126.

The circuit 128 may implement a bit-mask unit (e.g., BMU) circuit. The circuit 128 is generally operational to perform multiple bit-mask operations. The bit-mask operations generally include, but are not limited to, setting one or more bits, clearing one or more bits and testing one or more bits in a destination according to an immediate mask operand.

The circuit 130 may implement a DALU register file circuit. The circuit 130 may be operational to buffer multiple data items received from the circuits 92, 128 and 132. The read data may be received from the circuit 92 through the circuit 94 via the signal MRD. The signal MWD may be used to transfer the write data to the circuit 92 via the circuit 94.

The circuit 132 may implement multiple (e.g., 6, 8 or 12) arithmetic logic unit (e.g., ALU) circuits. Each circuit 132 may be operational to perform a variety of arithmetic operations on the data stored in the circuit 130. The arithmetic operations may include, but are not limited to, addition, subtraction, shifting and logical operations.

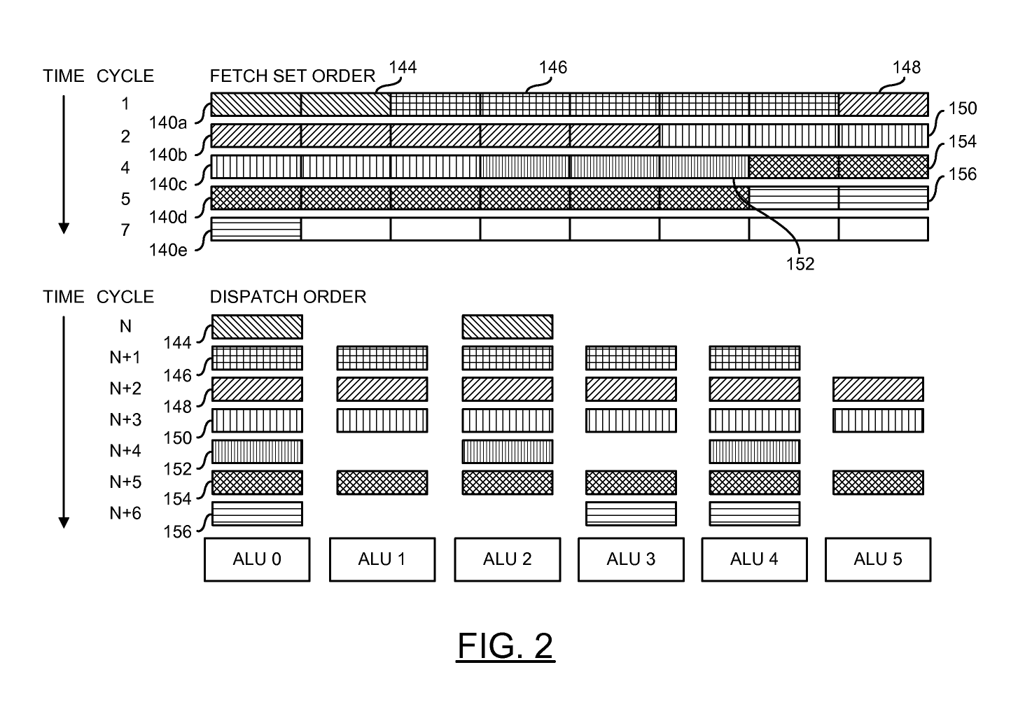

Referring to FIG. 2, a diagram illustrating an order for fetching and dispatching sets of instructions is shown. In the illustrated example, multiple fetch sets 140a-140e may be read in a fetch set order from the instruction memory 92 into a fetch set buffer. The reading from the instruction memory 92 may be performed sequentially with or without gaps between the cycles (e.g., cycles 1-7).

Each fetch set 140a-140e may match the width (e.g., 136 bits) of the core program bus width. Other widths of the fetch sets 140a-140e and the instruction words may be implemented to meet the criteria of a particular application.

In the example, the fetch set 140a may include all of a variable length execution set (e.g., VLES) 144, all of a VLES 146 and an initial portion of a VLES 148. The fetch set 140b may include a remaining portion of the VLES 148 and an initial portion of a VLES 150. The fetch set 140c may include a remaining portion of the VLES 150, all of a VLES 152 and an initial portion of a VLES 154. The fetch set 140d may include a remaining portion of the VLES 154 and an initial portion for the VLES 156. The fetch set 140e may include a remaining portion of the VLES 156.

The variable length execution sets 144-156 may be extracted from the fetch sets 140a-140e. In general, a single VLES may be dispatched to the ALU 0-ALU 5 in each cycle (e.g., the cycles N to N+6). For example, the two instruction words of the VLES 144 may be dispatched to the ALU 0 and the ALU 2 in the cycle N. The five instruction words of the VLES 146 may be dispatched to ALU 0-ALU 4 in the cycle N+1. The six instruction words of the VLES 148 may be dispatched to ALU 0-ALU 5 in the cycle N+2, and so on. In some embodiments of the pipeline, the execution stage(s) may occur after the dispatch stage and thus N=2. In other embodiments of the pipeline, one or more other stages may reside between the dispatch stage(s) and the execution stage(s) and thus N may be greater than 2.

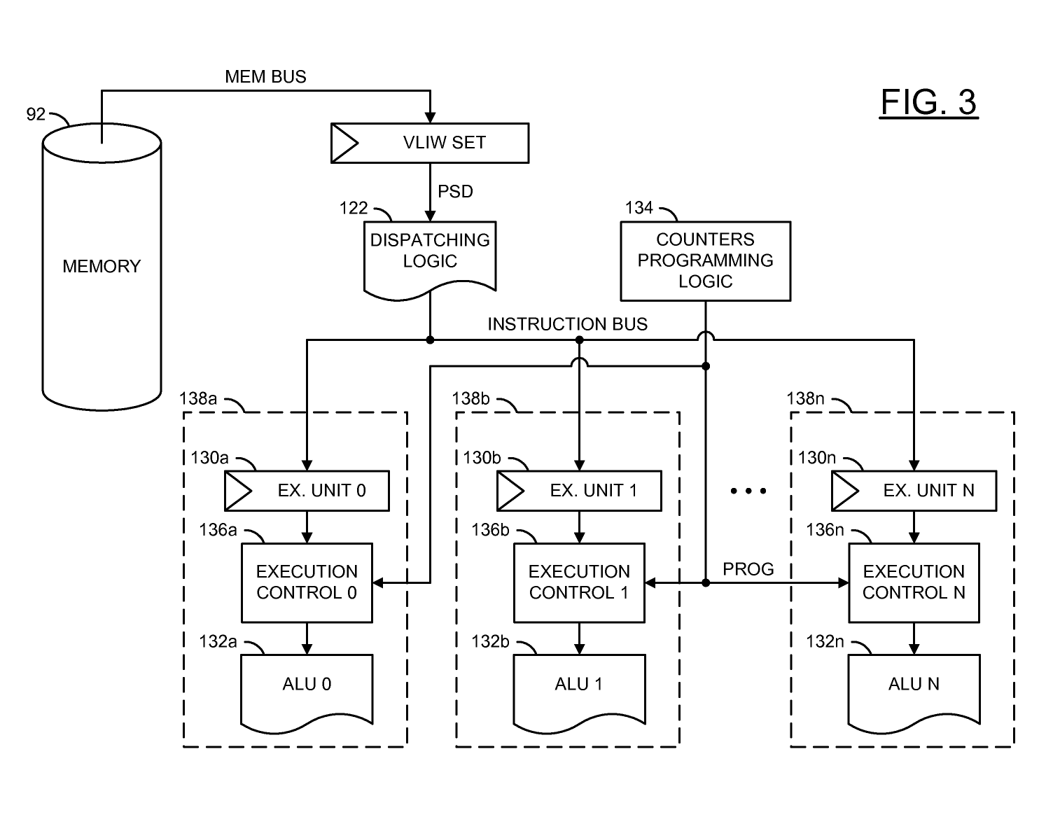

Referring to FIG. 3, a block diagram of a portion of the apparatus 90 is shown in accordance with a preferred embodiment of the present invention. The apparatus 90 generally comprises the circuit 92, the circuit 122, multiple portions of the circuit 130 (e.g., 130a-130n), multiple circuits 132 (e.g., 132a-132n), a block (or circuit) 134 and multiple blocks (or circuits) 136a-136n. The circuits 130a-130n, 132a-132n and 136a-136n may be arranged within respective blocks (or circuits) 138a-138n. The circuits 92-138n may represent modules and/or blocks that may be implemented as hardware, software, a combination of hardware and software, or other implementations. The signal PDS may be received by the circuit 122. A programming signal (e.g., PROG) may be generated by the circuit 134 and transferred to the circuits 136a-136n. The instruction bus may carry instructions from the circuit 122 to the circuits 130a-130n.

Each circuit 130a-130n may implement an execution unit register within the circuit 130. The circuits 130a-130n are generally operational to buffer instructions dispatched from the circuit 122 via the instruction bus. The buffered instructions may be presented to the circuits 136a-136n.

Each circuit 132a-132n may implement an execution unit circuit. In some embodiments, the circuits 132a-132n may implement the ALUs show in FIGS. 1 and 2. The circuits 132a-132n are generally operational to execute the instructions received from the circuits 136a-136n. One or more execution cycles may be used to process each instruction. Where the apparatus 90 implements a pipelined processor, the circuits 132a-132n may operate on multiple instructions in each cycle (e.g., an instruction in a multiply stage of the pipeline and another instruction in an execution stage of the pipeline).

The circuit 134 may implement a counter programming logic circuit. The circuit 134 is generally operational to program the circuits 136a-136n based on parameters received in the fetch sets. The parameters may include, but are not limited to, a count value for a number of consecutive execution cycles (or slots) that may be performed by the circuits 132a-132n, a starting address of an initial instruction in a loop, an ending address of a final instruction in the loop and a number of times that the loop should be executed. The parameters may be presented to the circuits 136a-136n via the signal PROG.

Each circuit 136a-136n may implement an execution control circuit. The circuits 136a-136n may be operational to count a number of consecutive execution cycles (or slots) executed by a corresponding circuit 132a-132n. Each circuit 136a-136n may be programmed with an individual count value. When a count expires, the corresponding circuit 136a-136n may stop execution in the corresponding circuit 132a-132n during one or more of the execution cycles in response to the expiration. The circuits 136a-136n may also be operational to perform short hardware looping of the instructions received from the circuit 122. The circuits 136a-136n may be programmed with the starting address of a loop, the ending address and the number of times that the loop should be executed. The instructions of a loop may be stored in a local buffer within the circuits 136a-136n. During each pass through the loops, the instructions may be read sequentially from the local buffer and presented to the corresponding circuits 132a-132n for execution. In some embodiments, the circuits 136a-136n may implement both the short hardware loop and the execution cycle counting to support efficient coding in the software.

The circuits 138a-138n may implement execution unit circuits. Each circuit 138a-138n is generally operational to execute the instructions received from the circuit 122 on the instruction bus. Execution of the instructions may include performing short hardware loops and/or execution cycle (slot) counts. The short hardware loops generally permit each circuit 138a-138n to independently loop through one or more instructions a programmable number of times (or iterations) before continuing with a next operation in the program. The execution cycle counter generally permits each circuit 138a-138n to execute a sequence of one or more particular instructions over a limited number of execution cycles. Once the limited number of execution cycles has been reached, the corresponding circuit 138a-138n may execute no-operation (e.g., NOP) instructions during the remaining execution cycles in a given operation of the software program. Once the operation has been completed, the circuits 138a-138n may restart the execution cycle counters and resume execution instructions dispatched from the circuit 122.

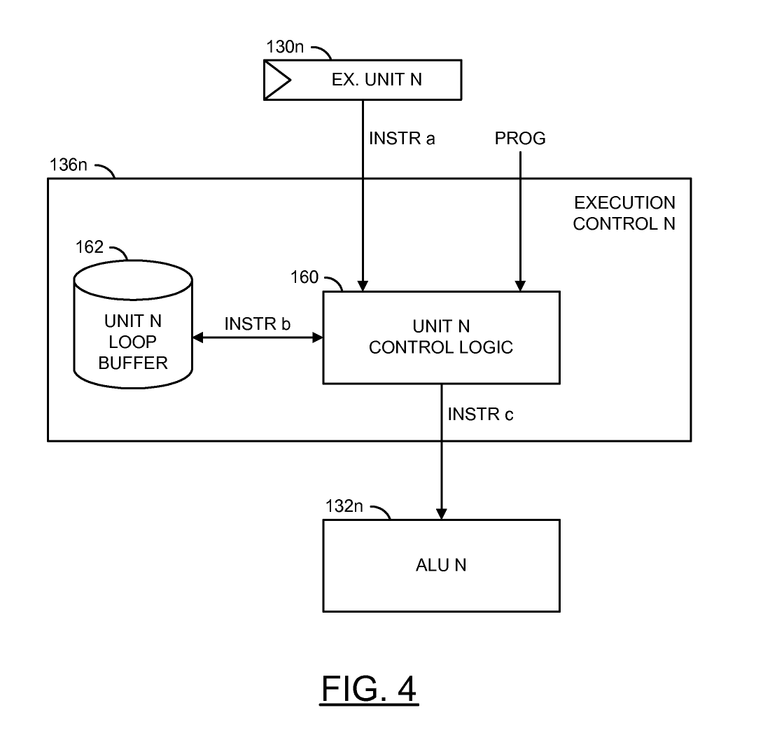

Referring to FIG. 4, a detailed block diagram of an example implementation of the circuit 136n. The implementation of the circuits 136a-136m may be similar to the circuit 136n. The circuit 136n generally comprises a block (or circuit) 160 and a block (or circuit) 162. The circuits 160-162 may represent modules and/or blocks that may be implemented as hardware, software, a combination of hardware and software, or other implementations. An instruction signal (e.g., INSTRa) may be generated by the circuit 130n and transferred to the circuit 160. The circuit 160 may also receive the signal PROG. A bidirectional instruction signal (e.g., INSTRb) may be exchanged between the circuit 160 and the circuit 162. The circuit 160 may generate an instruction signal (e.g., INSTRc) received by the circuit 132n.

The circuit 160 may implement a unit control logic circuit. The circuit 160 is generally operational to control a short hardware loop in the circuit 138n. The circuit 160 may write a sequence of instructions in a loop within a given operation of a software program in the circuit 162. The starting address, the ending address and the loop count value may be programmed into the circuit 160 by the circuit 134 using the signal PROG. The circuit 160 may subsequently read the instructions from the circuit 162 and transfer the instructions sequentially to the circuit 132n for execution. The circuit 160 may repeat the reads and transfers of the instructions based on the loop count value.

The circuit 162 may implement a local unit loop buffer circuit. The circuit 162 is generally operational to store the instructions of a loop as written by the circuit 160. The circuit 162 may present the instructions back to the circuit 160 once during each iteration of the loop.

Each circuit 136a-136n generally implements independent short hardware loops for each circuit 138a-138n (each execution unit or set of execution units). Therefore, information of the loop iterations and loop instructions may be stored in each circuit 138a-138n independently. The instruction information is generally stored on the execution unit instruction level, and not the VLIW level as in common implementations.

By way of example, the circuits 138a-138n may be programmed so that a loop is executed a maximum(a,b,c) times during an operation in the software as follows (where ∥ indicates parallel or simultaneous execution in the circuits 138a-138n):

| INSTRUCTIONS | COMMENTS |
|---|---|
| Do_following_instruction_x_times_on_ALU1 | a \|\| |
| Do_following_instruction_x_times_on_ALU2 | b \|\| |
| Do_following_instruction_x_times_on_ALU3 | c; 1 cycles 3 words |
| D1=op1(d1) \|\| D2=op2(d2) \|\| D3=op3(d3) | ; max(a,b,c) cycles 3 |
| | words |
| D=D1*D2 | ; 1 cycle 1 word |
| D=D*D3 | ; 1 cycle 1 word |

Overall, the operation generally utilizes 3+maximum(a,b,c) execution cycles and 8 words of the code size. For values of a=20, b=21 and c=25, the execution time may be 28 cycles (e.g., maximum(20,21,25)=25) and the code size is 8 words. A normalized comparison of the example to a couple of existing approaches is shown in Table I as follows:

TABLE I

| | Execution | Code |
|---|---|---|
| | Time (cycles) | Size (words) |
| Circuits 138a-138n | 28/28 = 100% | 8/8 = 100% |
| Common sequential | 71/28 = 254% | 8/8 = 100% |
| Common semi-parallel | 42/28 = 150% | 71/8 = 888% |

Table I generally illustrates that the circuits 138a-138n may be more efficient than the common approaches. The common sequential approach is approximately 154% worse in execution time. The common semi-parallel approach is approximately 50% worse in execution time and has a 788% larger code size.

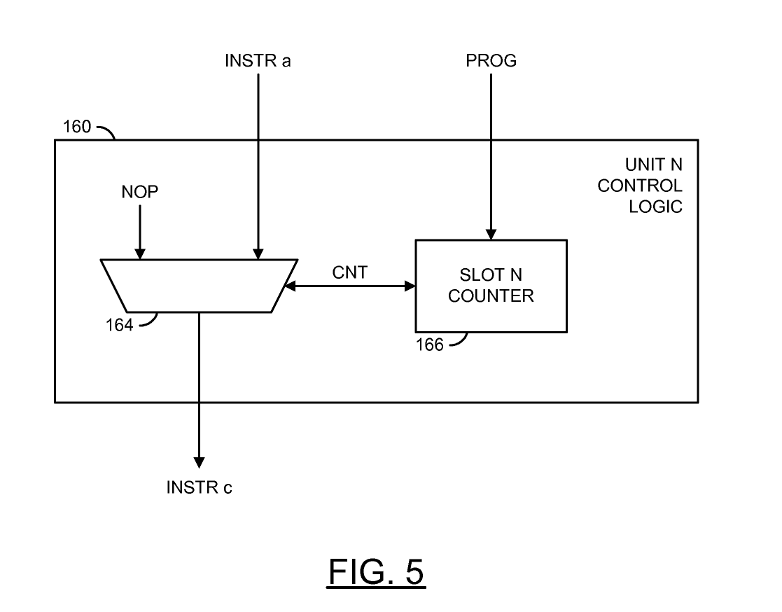

Referring to FIG. 5, a detailed block diagram of an example implementation of the circuit 160 is shown. The circuit 160 generally comprises a block (or circuit) 164 and a block (or circuit) 166. The circuits 164-166 may represent modules and/or blocks that may be implemented as hardware, software, a combination of hardware and software, or other implementations. The signal INSTRa may be received by the circuit 164. The signal PROG may be received by the circuit 166. A control signal (e.g., CNT) may be generated by the circuit 166 and presented to the circuit 164. The circuit 164 may generate and present the signal INSTRc.

The circuit 164 may implement a multiplexer circuit. The circuit 164 is generally operational to route the signal INSTRa and a NOP instruction to the signal INSTRc in response to the signal CNT. In some embodiments, the NOP instruction may be implemented external to the circuit 164 and transferred to the circuit 164. In other embodiments, the NOP instruction may be hardwired into the design of the circuit 164.

The circuit 166 may implement a slot counter circuit. The circuit 166 is generally operational to count a number of times that an execution slot (or cycle) is executed by the circuit 132n. The count value may be programmed into the circuit 166 via the signal PROG. For each slot (or cycle) executed, the circuit 166 generally decrements the count value and checks for a zero value. While the count value is non-zero, the circuit 166 may command the circuit 164 to route an instruction from the signal INSTRa to the signal INSTRc using the control signal CNT. Once the count value has reached zero, the circuit 166 may command the circuit 164 to route the NOP instruction to the signal INSTRc using the signal CNT.

Each circuit 138a-138n may implement independent programmable execution slot counters. The slot counters (e.g., circuit 166) generally allow a programmed number of times that a particular execution unit or units (e.g., circuits 132a-132n) may execute the instructions. Assembly instructions and/or directives may be used to program the counter functionality. In some embodiments, each circuit 166 within two or more of the circuits 136a-136n may be linked together in a chain of master/slave relationships. When a master counter expires, each linked slave counter may also be forced to expire independently of the current count values in the slaves. Conversely, a slave counter may expire without impacting the master counter. In other embodiments, each circuit 166 within two or more of the circuits 136a-136n may be linked together such that a first of the counters to expire forces all of the linked counters to expire simultaneously.

The circuits 136a-136n generally enable improvements in a cycle count and/or a program size of the software code. The improvements may include a reduction of memory power and a reduction in program cache miss cycles.

Returning to the example of the CAVLC/CABAC operation, the code_block_3 and the code_block_2 instructions may be arranged as follows:

| CODE_BLOCK_3 | CODE_BLOCK_2 | COMMENTS |
|---|---|---|
| [instruction 1] \|\| | [start_execution_for_ALU_3 Z] | ; enable ALU 3 |
| | | ; for Z time |
| | | only |
| [instruction 2] \|\| | [store indication] | ; store A[0] |
| [instruction 3] \|\| | [store indication] | ; store A[1] |
| . . . | | |
| . . . | | |
| [instruction 16] \|\| | [store indication] | ; store A[14] |
| [instruction 17] \|\| | [store indication] | ; store A[15] |
| [instruction 18] \|\| | [end_execution_for_ALU_3] | |

A distance between the start_execution_for_ALU_3 and the end_execution_for_ALU_3 may be the maximal value of Z execution cycles. The addition of the circuits 164 and 166 generally reduces the number of circuits 132a-132n used to execute the code_block_2 because (i) the counter decrement operation and (ii) the comparison of the decremented result to zero operation may be performed by the circuit 166 rather than the circuits 132a-132n. Therefore, the circuits 164 and 166 may reduce the size of the operation in the software program and the cycle counts used to execute the operation.

The circuit 100 may implement independent short hardware loops for each execution unit or set of execution units. Each circuit 138a-138n may include a local instruction buffer to hold the instructions in a current loop. Implementing an individual loop counter and instruction buffer in each circuit 138a-138n generally provides the circuit 100 with a capability to run different numbers of loop iterations in each execution unit. Implementing the hardware execution cycle (or slot) counters may define a number of cycles when a particular execution unit is operational. An assembly language directives and instructions may also be provided for programming the execution cycle counters. For example, the instruction “start_execution_for_ALU_3 Z” for the code_block_2 may program the execution cycle counter for ALU 3 to execute Z number of times. The corresponding instruction “end_execution_for_ALU_3” may stop the execution cycle counter. In another example, an instruction “start_execution_for_ALU_1_2_3 #N, unit_label_name” may program the execution cycle counters for ALU 1, ALU 2 and ALU 3 to execute #N times. The “unit_label_name” may be placed at the end of the instruction blocks. A program counter may be compared to the unit_label_name to determine when to stop the execution.

The functions performed by the diagrams of FIGS. 1-5 may be implemented using one or more of a conventional general purpose processor, digital computer, microprocessor, microcontroller, RISC (reduced instruction set computer) processor, CISC (complex instruction set computer) processor, SIMD (single instruction multiple data) processor, signal processor, central processing unit (CPU), arithmetic logic unit (ALU), video digital signal processor (VDSP) and/or similar computational machines, programmed according to the teachings of the present specification, as will be apparent to those skilled in the relevant art(s). Appropriate software, firmware, coding, routines, instructions, opcodes, microcode, and/or program modules may readily be prepared by skilled programmers based on the teachings of the present disclosure, as will also be apparent to those skilled in the relevant art(s). The software is generally executed from a medium or several media by one or more of the processors of the machine implementation.

The present invention may also be implemented by the preparation of ASICs (application specific integrated circuits), Platform ASICs, FPGAs (field programmable gate arrays), PLDs (programmable logic devices), CPLDs (complex programmable logic device), sea-of-gates, RFICs (radio frequency integrated circuits), ASSPs (application specific standard products), one or more monolithic integrated circuits, one or more chips or die arranged as flip-chip modules and/or multi-chip modules or by interconnecting an appropriate network of conventional component circuits, as is described herein, modifications of which will be readily apparent to those skilled in the art(s).

The present invention thus may also include a computer product which may be a storage medium or media and/or a transmission medium or media including instructions which may be used to program a machine to perform one or more processes or methods in accordance with the present invention. Execution of instructions contained in the computer product by the machine, along with operations of surrounding circuitry, may transform input data into one or more files on the storage medium and/or one or more output signals representative of a physical object or substance, such as an audio and/or visual depiction. The storage medium may include, but is not limited to, any type of disk including floppy disk, hard drive, magnetic disk, optical disk, CD-ROM, DVD and magneto-optical disks and circuits such as ROMs (read-only memories), RAMS (random access memories), EPROMs (erasable programmable ROMs), EEPROMs (electrically erasable programmable ROMs), UVPROM (ultra-violet erasable programmable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, audio storage and/or audio playback devices, video recording, video storage and/or video playback devices, game platforms, peripherals and/or multi-chip modules. Those skilled in the relevant art(s) would understand that the elements of the invention may be implemented in other types of devices to meet the criteria of a particular application. As used herein, the term “simultaneously” is meant to describe events that share some common time period but the term is not meant to be limited to events that begin at the same point in time, end at the same point in time, or have the same duration.

While the invention has been particularly shown and described with reference to the preferred embodiments thereof, it will be understood by those skilled in the art that various changes in form and details may be made without departing from the scope of the invention.

1. An apparatus comprising:
a first circuit configured to dispatch a plurality of sets in a sequence, wherein each of said sets comprises a plurality of instructions; and
a plurality of second circuits configured to (i) execute said sets during a plurality of execution cycles respectively and (ii) stop said execution in a particular one of said second circuits during one or more of said execution cycles in response to an expiration of a particular counter that corresponds to said particular second circuit.

2. The apparatus according to claim 1, wherein (i) said particular counter is programmed with a value, (ii) said sets perform one of a plurality of operations in a program and (iii) said value is smaller than a number of said sets.

3. The apparatus according to claim 2, wherein said value is calculated by said program.

4. The apparatus according to claim 1, wherein said particular second circuit is further configured to execute a no-operation instruction during said execution cycles after said expiration of said particular counter.

5. The apparatus according to claim 1, wherein said particular second circuit is further configured to execute a plurality of particular ones of said instructions in a loop while said particular counter is active.

6. The apparatus according to claim 5, wherein said particular second circuit is further configured to store said particular instructions in a particular one of a plurality of buffers, wherein said buffers correspond to said second circuits respectively.

7. The apparatus according to claim 6, wherein said particular second circuit is further configured to read said particular instructions in a sequence from said particular buffer in accordance with said loop.

8. The apparatus according to claim 1, wherein another of second circuits is further configured to stop said execution of said sets during one or more of said execution cycles in response to an expiration of another counter that corresponds to said another second circuit.

9. The apparatus according to claim 8, wherein said particular counter is programmed with a different value than said another counter.

10. The apparatus according to claim 1, wherein said apparatus is implemented as one or more integrated circuits.

11. A method for controlling a sequence of parallel executions, comprising the steps of:
(A) dispatching a plurality of sets in a sequence, wherein each of said sets comprises a plurality of instructions;
(B) executing said sets during a plurality of execution cycles respectively in a plurality of circuits; and
(C) stopping said executing in a particular one of said circuits during one or more of said execution cycles in response to an expiration of a particular counter that corresponds to said particular circuit.

12. The method according to claim 11, further comprising the step of:
programming said particular counter with a value, wherein (i) said sets perform one of a plurality of operations in a program and (ii) said value is smaller than a number of said sets.

13. The method according to claim 12, wherein said value is calculated by said program.

14. The method according to claim 11, further comprising the step of:
executing a no-operation instruction in said particular circuit during said execution cycles after said expiration of said particular counter.

15. The method according to claim 11, wherein said particular circuit executes a plurality of particular ones of said instructions in a loop while said particular counter is active.

16. The method according to claim 15, further comprising the step of:
storing said particular instructions in a particular one of a plurality of buffers, wherein said buffers correspond to said circuits respectively.

17. The method according to claim 16, further comprising the step of:
reading said particular instructions in a sequence from said particular buffer in accordance with said loop.

18. The method according to claim 11, further comprising the step of:
stopping said executing of said sets in another of said circuits during one or more of said execution cycles in response to an expiration of another counter that corresponds to said another circuit.

19. The method according to claim 18, wherein said particular counter is programmed with a different value than said another counter.

20. An apparatus comprising:
means for dispatching a plurality of sets in a sequence, wherein each of said sets comprises a plurality of instructions;
means for executing said sets during a plurality of execution cycles respectively; and
means for stopping said executing in a particular one of said means for executing during one or more of said execution cycles in response to an expiration of a particular counter that corresponds to said particular means for executing.
